(19) United States
(12) Patent Application Publication
(10) Pub. No.: US 2019/0014081 A1
(43) Pub. Date: Jan. 10, 2019

(54) APPARATUS FOR SUPPORTING COMMUNICATION BETWEEN SEPARATE NETWORKS AND METHOD FOR THE SAME

(71) Applicant: ELECTRONICS AND TELECOMMUNICATIONS RESEARCH INSTITUTE, Daejeon (KR)

(72) Inventors: Dong-Wook KIM, Daejeon (KR); Byung-Gil MIN, Cheongju-si (KR)

(21) Appl. No.: 15/805,292

(22) Filed: Nov. 7, 2017

(30) Foreign Application Priority Data
Jul. 4, 2017 (KR) 10-2017-0085001

(51) Int. Cl. H04L 29/06; H04L 12/931; H04L 12/947

(52) U.S. Cl. CPC H04L 63/0209; H04L 49/20; H04L 49/25; H04L 69/16; H04L 63/145; H04L 63/101; H04L 49/40

(57) ABSTRACT

An apparatus for supporting data communication between separate networks, which includes an internal network connection module for sending data, received from an internal network, to an intermediate connection module through one-way communication and sending data, received from the intermediate connection module through first one-way communication under the control of an internal network bypass switch, to the internal network; an external network connection module for sending data, received from the intermediate connection module through one-way communication, to an external network and sending data, received from the external network, to the intermediate connection module through second one-way communication under the control of an external network bypass switch; and the intermediate connection module for temporarily storing and managing intermediate data received from the internal network connection module or the external network connection module.

### CROSS REFERENCE TO RELATED APPLICATION

This application claims the benefit of Korean Patent Application No. 10-2017-0085001, filed Jul. 4, 2017, which is hereby incorporated by reference in its entirety into this application.

### BACKGROUND OF THE INVENTION

### 1. Technical Field

The present invention relates generally to supporting secure data communication between an internal network and an external network, and more particularly to an apparatus and method for supporting data communication between an internal network and an external network by controlling data communication from the external network to the internal network.

### 2. Description of Related Art

In order to completely prevent attacks from external networks, it is necessary to separate an internal network from external networks, that is, network separation is required. However, because it is necessary to transmit log information about the internal network, a physical one-way data transfer method, which may fundamentally prevent attacks from an external network but allow data transfer to the external network, has been developed.

Although such an environment in which only one-way data transfer from an internal network to an external network is allowed by separating the internal network from the external network using a physical one-way data transfer device is configured, data transfer from the external network to the internal network may be needed according to the circumstances. For example, occasionally or when necessary, a program installed in an internal network device is required to be patched or vaccine software installed therein is required to be updated. To this end, the physical one-way data transfer device may be applied for data transfer from the external network to the internal network, or a demilitarized zone (DMZ) may be constructed using a firewall.

Waterfall's ‘FLIP’ is a physical apparatus for one-way data transfer, the orientation of which is reversible, and when this apparatus is applied, security updates and the like may be periodically downloaded from an external network to an internal network. In this case, two-way data transfer between the internal network and the external network is not allowed. That is, while ‘FLIP’ allows the reverse data transfer (from the external network to the internal network), one-way communication from the internal network to the external network must be interrupted.

Firewalls permit direct or indirect two-way communication between the internal network and the external network, in which case the internal network may be exposed to security threats. For example, even if a firewall is present, an internal network device infected with a backdoor may be controlled in real time by an attacker in the external network. This problem may arise from a physical bidirectional link between the internal network device and the external network device.

Therefore, it is necessary to develop a system and method including a network-based data link structure in which the disadvantages of the ‘FLIP’ device are resolved and in which direct bidirectional communication between an internal network and an external network is physically prevented.

The above-described information about the related art has been retained by the inventors for the purpose of developing the present invention or was obtained during the process of developing the present invention. Also, it should be appreciated that this information did not necessarily belong to the public domain before the patent filing date of the present invention.

### Documents of Related Art

(Patent Document 1) Korean Patent No. 10-1569200.

### SUMMARY OF THE INVENTION

An object of the present invention is to provide an apparatus and method for supporting data communication between separate networks by allowing data transmission from an internal network to an external network but controlling data transmission from the external network to the internal network.

Another object of the present invention is to provide an apparatus and method for supporting data communication between separate networks by physically preventing direct two-way communication between an internal network and an external network.

An embodiment of the present invention provides an apparatus for supporting data communication between separate networks, which includes an internal network connection module for sending data, received from an internal network, to an intermediate connection module through one-way communication and sending data, received from the intermediate connection module through first one-way communication under control of an internal network bypass switch, to the internal network; an external network connection module for sending data, received from the intermediate connection module through one-way communication, to an external network and sending data, received from the external network, to the intermediate connection module through second one-way communication under control of an external network bypass switch; and the intermediate connection module for temporarily storing and managing intermediate data received from the internal network connection module or the external network connection module.

Here, the internal network bypass switch and the external network bypass switch may operate in a mutually exclusive manner.

Here, the internal network connection module may control the internal network bypass switch by sending a control signal thereto.

Here, the internal network bypass switch and the external network bypass switch may be controlled using one or more of enabling/disabling a bypass connection and enabling/disabling supply of power.

Here, the external network bypass switch may be controlled by receiving an external network bypass switch control signal that is generated in the internal network connection module or in the internal network bypass switch.

Here, if the first one-way communication is enabled, the external network bypass switch control signal to be sent to the external network bypass switch may be a control signal for disabling the second one-way communication.

Here, the intermediate connection module may be configured to check at least one of whether the intermediate data include malicious code, whether integrity of the intermediate data is maintained, and whether the intermediate data are infected with viruses, and to send only data that pass checking when sending the intermediate data.

Here, the internal network connection module may be configured to determine whether to perform data communication with an external network device, which is connected to the external network, using a whitelist, and to control the internal network bypass switch and the external network bypass switch depending on determination of whether to perform data communication.

Here, the intermediate connection module may request two-way communication with the external network connection module when the second one-way communication is enabled by the external network bypass switch, when the first one-way communication is disabled by the internal network bypass switch, or periodically.

Another embodiment of the present invention provides a method for supporting data communication between separate networks, which includes controlling first one-way communication from an intermediate connection module to an internal network connection module using an internal network bypass switch, the intermediate connection module communicating between the internal network connection module, which communicates with an internal network, and an external network connection module, which communicates with an external network; controlling second one-way communication from the external network connection module to the intermediate connection module using an external network bypass switch; communicating with the internal network in such a way that the internal network connection module and the intermediate connection module communicate with each other through one-way communication from the internal network connection module to the intermediate connection module and through the first one-way communication; communicating with the external network in such a way that the intermediate connection module and the external network connection module communicate with each other through one-way communication from the intermediate connection module to the external network connection module and through the second one-way communication; and temporarily storing and managing intermediate data when the intermediate connection module receives the data.

Here, the internal network bypass switch and the external network bypass switch may operate in a mutually exclusive manner.

Here, the method may further include delivering an internal network bypass switch control signal generated in the internal network connection module to the internal network bypass switch, and controlling the first one-way communication may be configured to control the internal network bypass switch depending on the internal network bypass switch control signal.

Here, controlling the first one-way communication may be configured to control the first one-way communication using one or more of enabling/disabling a bypass connection of the internal network bypass switch and enabling/disabling supply of power to the internal network bypass switch, and controlling the second one-way communication may be configured to control the second one-way communication using one or more of enabling/disabling a bypass connection of the external network bypass switch and enabling/disabling supply of power to the external network bypass switch.

Here, the method may further include sending an external network bypass switch control signal generated in the internal network connection module or in the internal network bypass switch to the external network bypass switch, and controlling the second one-way communication may be configured to control the external network bypass switch depending on the external network bypass switch control signal.

Here, if the first one-way communication is enabled, the external network bypass switch control signal to be sent to the external network bypass switch may be a control signal for disabling the second one-way communication.

Here, temporarily storing and managing the intermediate data may include checking at least one of whether the intermediate data include malicious code, whether integrity of the intermediate data is maintained, and whether the intermediate data are infected with viruses; and communicating with the internal network and communicating with the external network may be configured to send only data that pass the checking when sending the intermediate data.

Here, the method may further include determining whether to perform data communication between a device connected to the internal network and a device connected to the external network using a whitelist; and controlling the internal network bypass switch and the external network bypass switch depending on the determining whether to perform data communication.

Here, the method may further include requesting two-way communication between the intermediate connection module and the external network connection module when the second one-way communication is enabled by the external network bypass switch, when the first one-way communication is disabled by the internal network bypass switch, or periodically.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view that shows the configuration of a system for supporting data communication between separate networks according to an embodiment of the present invention;

FIG. 2 is a block diagram that shows an example of the apparatus for supporting data communication between separate networks, illustrated in FIG. 1;

FIG. 3 is a block diagram that shows an example of the relationship between the components of the apparatus for supporting data communication between separate networks, illustrated in FIG. 2;

FIG. 4 is a block diagram that shows an internal network connection module according to an embodiment of the present invention;

FIG. 5 is a block diagram that shows an intermediate connection module according to an embodiment of the present invention;

FIG. 6 is a block diagram that shows an external network connection module according to an embodiment of the present invention;

FIG. 7 is a view that shows a signal transmission line used in an apparatus for supporting data communication between separate networks according to an embodiment of the present invention;

FIG. 8 is a view that shows a method for transmitting one-way UDP data from an internal network device to an external network device according to an embodiment of the present invention;

FIG. 9 is a view that shows a method for transmitting TCP data from an internal network device to an external network device according to an embodiment of the present invention;

FIG. 10 is a view that shows a method for transmitting TCP data from an internal network device to an external network device according to an embodiment of the present invention;

FIG. 11 is a view that shows the entire process of a method for transmitting TCP data from an internal network device to an external network device according to an embodiment of the present invention;

FIG. 12 is a view that shows the entire process of a method for transmitting TCP data from an external network device to an internal network device according to an embodiment of the present invention; and

FIG. 13 is a block diagram that shows another example of the apparatus for supporting data communication between separate networks, illustrated in FIG. 1.

### DESCRIPTION OF THE PREFERRED EMBODIMENTS

The present invention may be variously changed, and may have various embodiments, and specific embodiments will be described in detail below with reference to the attached drawings. The effects and features of the present invention and methods of achieving them will be apparent from the following exemplary embodiments, which will be described in more detail with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

However, the present invention is not limited to the embodiments to be described below, but all or some of the embodiments may be selectively combined and configured, so that the embodiments may be modified in various ways. It will be understood that, although the terms “first,” “second,” etc. may be used herein to describe various elements, these elements are not intended to be limited by these terms. These terms are only used to distinguish one element from another element. Also, a singular expression includes a plural expression unless a description to the contrary is specifically pointed out in context. Also, it should be understood that terms such as “include” or “have” are merely intended to indicate that features, components, parts, or combinations thereof are present, and are not intended to exclude the possibility that one or more other features, components, parts, or combinations thereof will be present or added.

Hereinafter, embodiments of the present invention will be described in detail with reference to the accompanying drawings. In the following description of the present invention, the same reference numerals are used to designate the same or similar elements throughout the drawings, and repeated descriptions of the same components will be omitted.

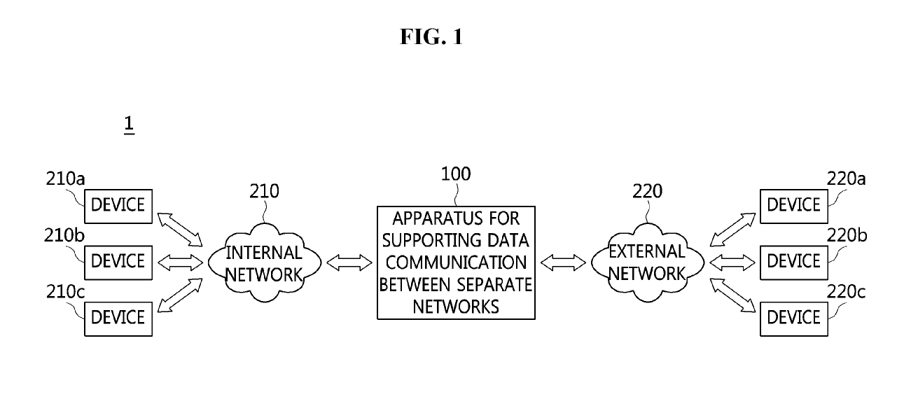

FIG. 1 is a view that shows the configuration of a system for supporting data communication between separate networks according to an embodiment of the present invention.

Referring to FIG. 1, in the system for supporting data communication between separate networks according to an embodiment of the present invention, an apparatus 100 for supporting data communication between separate networks is interconnected with an internal network 210 and an external network 220. Also, the internal network 210 is interconnected with one or more devices 210a, 210b and 210c, and the external network 220 is interconnected with one or more devices 220a, 220b and 220c.

The apparatus 100 for supporting data communication between separate networks according to an embodiment of the present invention supports communication between the internal network 210 and the external network 220 using an internal network connection module, an external network connection module, and an intermediate connection module. Specifically, the internal network connection module sends data, received from the internal network, to the intermediate connection module through one-way communication and sends data, received from the intermediate connection module through first one-way communication under the control of an internal network bypass switch, to the internal network. The external network connection module sends data, received from the intermediate connection module through one-way communication, to the external network and sends data, received from the external network, to the intermediate connection module through second one-way communication under the control of an external network bypass switch. The intermediate connection module temporarily stores and manages intermediate data received from the internal network connection module or the external network connection module.

Communication between the internal network 210 and the external network 220 is classified into two phases based on the intermediate connection module, that is, communication between the internal network connection module and the intermediate connection module and communication between the intermediate connection module and the external network connection module.

Here, the communication between the internal network connection module and the intermediate connection module and the communication between the intermediate connection module and the external network connection module may include communication through a wireless network, communication through a wired network using an Ethernet cable, communication using a data communication cable including Universal Serial Bus (USB), and the like.

Here, the communication between the internal network 210 and the internal network connection module and the communication between the external network 220 and the external network connection module may include communication through a wireless network, communication through a wired network using an Ethernet cable, communication using a data communication cable including USB, and the like.

Here, the communication between the internal network connection module and the intermediate connection module may be performed by one-way communication from the internal network connection module to the intermediate connection module and the first one-way communication from the intermediate connection module to the internal network connection module, which is controlled by the internal network bypass switch. Also, the communication between the intermediate connection module and the external network connection module may be performed through one-way communication from the intermediate connection module to the external network connection module and the second one-way communication from the external network connection module to the intermediate connection module, which is controlled by the external network bypass switch.

Here, the communication between the internal network 210 and the external network 220 may include one-way communication from the internal network 210 to the external network 220 and two-way communication therebetween under the control of the internal network bypass switch and the external network bypass switch.

In an alternative embodiment, the apparatus 100 for supporting data communication between separate networks may include a switch operation mode selection unit for selecting a switch operation mode for the internal network bypass switch and the external network bypass switch. When the switch operation mode is an exclusive operation mode, the internal network bypass switch and the external network bypass switch may operate in a mutually exclusive manner.

Here, if the internal network bypass switch and the external network bypass switch operate in a mutually exclusive manner, when the first one-way communication is enabled by the internal network bypass switch, the second one-way communication may be disabled by the external network bypass switch. Also, when the second one-way communication is enabled by the external network bypass switch, the first one-way communication may be disabled by the internal network bypass switch.

If the switches operate exclusively, while a two-way session initiated from the internal network 210 is present, the apparatus 100 for supporting data communication between separate networks may use the internal network connection module as a two-way communication device. Also, while the internal network connection module is used as a two-way communication device, a two-way connection between the external network connection module and the external network 220 is physically prevented. Conversely, while there is no two-way session initiated from the internal network 210, the external network connection module may be used as a two-way communication device. Also, while the external network connection module is used as a two-way communication device, a two-way connection between the internal network connection module and the internal network 210 is physically prevented. However, regardless of this, the internal network devices 210a to 210c are always allowed to send one-way data to the external devices 220a to 220c based on UDP.

Here, when the switch operation mode is a synchronous operation mode, the internal network bypass switch and the external network bypass switch operate synchronously, whereby both the internal network connection module and the external network connection module may operate as two-way communication devices at the same time.

For example, if the switch operation mode is a synchronous operation mode, when the internal network bypass switch is deactivated, the external network bypass switch may also be deactivated, and when the internal network bypass switch is activated, the external network bypass switch may also be activated.

According to an alternative embodiment, in the apparatus 100 for supporting data communication between separate networks, the internal network connection module may send a control signal to the internal network bypass switch in order to control the internal network bypass switch.

That is, the internal network connection module may control the internal network bypass switch.

Here, the control signal, which is a one-bit signal having the value ‘0’ or ‘1’, may be transmitted from the internal network connection module to the internal network bypass switch using a diode connected therebetween, and may be prevented from being transmitted in the reverse direction.

For example, the internal network connection module may deactivate the internal network bypass switch by sending a control signal having the value ‘0’ thereto. Also, the internal network connection module may activate the internal network bypass switch by sending a control signal having the value ‘1’ thereto.

Here, the internal network bypass switch may be controlled based on the start and the end of two-way traffic initiated from the internal network 210.

For example, when the internal network connection module receives a TCP SYN (synchronization) packet, configured with the 5-tuple (a source IP address, a source port number, a destination IP address, a destination port number, and a protocol in use) and initiated by any one of the internal network devices 210a to 210c, which means the start of a Transmission Control Protocol (TCP) session, the internal network connection module may request the internal network bypass switch to enable a bypass connection and to set a power ON state. Similarly, when the internal network connection module receives a TCP FIN (Finish) packet for the termination of the established TCP session, the internal network connection module may request the internal network bypass switch to disable a bypass connection and to set a power OFF state after a certain time period (for example, one second later).

Here, the internal network bypass switch may be controlled using a scheduling method.

For example, the internal network connection module may set a timer at intervals of 10 minutes and request the internal network bypass switch to be activated for the first 10 minutes and to be deactivated for the next 10 minutes.

Here, the internal network bypass switch may be controlled using a physical button or a physical switch.

For example, using a physical button for controlling the internal network bypass switch, settings for connecting or disconnecting the internal network bypass switch may be made, whereby the connection or disconnection of the internal network bypass switch may be controlled using the physical button.

Also, the internal network bypass switch may determine whether to activate or deactivate itself based on scheduling without explicit triggering by the internal network connection module.

In an alternative embodiment, the apparatus 100 for supporting data communication between separate networks may use at least one of enabling/disabling a bypass connection and enabling/disabling the supply of power in order to control each of the internal network bypass switch and the external network bypass switch.

That is, the first one-way communication or the second one-way communication may be enabled or disabled by enabling or disabling a bypass connection of the switch, and may also be enabled or disabled by enabling or disabling the supply of power to the switch. Also, the first one-way communication or the second one-way communication may be enabled or disabled using both enabling or disabling a bypass connection of the switch and enabling or disabling the supply of power to the switch.

For example, when the first one-way communication is disabled or interrupted in order to support only one-way communication from the internal network 210 to the external network 220, the supply of power to the internal network bypass switch may be interrupted and the bypass connection of the internal network bypass switch may be disabled. Also, when the second one-way communication is disabled or interrupted, the supply of power to the external network bypass switch may be interrupted and the bypass connection of the external network bypass switch may be disabled.

According to an alternative embodiment, in the apparatus 100 for supporting data communication between separate networks, the internal network bypass switch may send a control signal in order to control the external network bypass switch.

That is, the internal network bypass switch may control the external network bypass switch, whereby the external network bypass switch may be made to operate in conjunction with the operation of the internal network bypass switch.

Here, the control signal, which is a one-bit signal having the value ‘0’ or ‘1’, may be transmitted from the internal network bypass switch to the external network bypass switch using a diode connected therebetween, and may be prevented from being transmitted in the reverse direction.

For example, when the internal network bypass switch is activated and the first one-way communication is established, the external network bypass switch may be deactivated by sending a control signal having the value ‘0’ thereto. Also, when the internal network bypass switch is deactivated and the first one-way communication is blocked, the external network bypass switch may be activated by sending a control signal having the value ‘1’ thereto.

Here, the control signal having the value ‘1’, transmitted to the external network bypass switch, may be used as an instruction to activate the external network bypass switch, but may alternatively be used to indicate that the external network bypass switch can be activated.

For example, when it is found, using the control signal having the value ‘1’ transmitted to the external network bypass switch, that the external network bypass switch can be activated, the external network bypass switch is activated only when the second one-way communication is required.

According to an alternative embodiment, in the apparatus 100 for supporting data communication between separate networks, if the switch operation mode is an exclusive operation mode, when the first one-way communication is established or enabled, the internal network bypass switch may send a control signal to the external network bypass switch so as to interrupt or disable the second one-way communication.

That is, because the first one-way communication and the second one-way communication cannot be simultaneously enabled by disabling the second one-way communication when the first one-way communication is enabled, a two-way simultaneous connection between the internal network 210 and the external network 220 may be physically prevented.

That is, the two-way simultaneous connection between the internal network and the external network is physically prevented because the internal network bypass switch and the external network bypass switch operate in a mutually exclusive manner, whereby the internal network may be prevented from being controlled by an external attacker even when the internal network is exposed to a security threat.

According to an alternative embodiment, in the apparatus 100 for supporting data communication between separate networks, the internal network connection module may determine whether to communicate with the external network devices 220a to 220c, which are connected to the external network 220, using a whitelist, and may control the internal network bypass switch and the external network bypass switch based thereon.

Here, a whitelist for the internal network bypass switch may differ from a whitelist for the external network bypass switch, and the whitelists are not limited to being the same as each other.

Here, each of the whitelists may include the Internet Protocol (IP) addresses and the port numbers of the internal network devices 210a to 210c connected to the internal network 210, the IP addresses and the port numbers of the external network devices 220a to 220c connected to the external network 220, a communication protocol, information about whether two-way communication is available, the number of times communication is allowed during a day, the number of times communication is performed during a day, the length of time available for communication, and the like.

For example, when the whitelist for the internal network bypass switch includes information about one-way User Datagram Protocol (UDP) communication from the internal network device 210a to the external network device 220a, the apparatus 100 for supporting data communication between separate networks may allow data transmission from the internal network device 210a to the external network device 220a, but may deactivate the internal network bypass switch in order to prevent data transmission from the external network device 220a to the internal network device 210a. Similarly, when the whitelist for the external network bypass switch includes information about one-way UDP communication from the internal network device 210a to the external network device 220a, the apparatus 100 for supporting data communication between separate networks may allow data transmission from the internal network device 210a to the external network device 220a, but may deactivate the external network bypass switch in order to prevent data transmission from the external network device 220a to the internal network device 210a.

Here, each of the whitelists may be a whitelist for supporting conditional two-way communication by allowing data transmission from the internal network device 210a to the external network device 220a and by temporarily allowing data transmission from the external network device 220a to the internal network device 210a only when a two-way communication protocol session initiated by the internal network device 210a is present.

For example, when both the whitelists for the internal network bypass switch and the external network bypass switch are whitelists for supporting conditional two-way communication and when two-way communication between the internal network device 210a and the external network device 220a is allowed based thereon, each of the internal network bypass switch and the external network bypass switch may operate in order to temporarily allow two-way communication only when a two-way communication protocol session corresponding thereto is present. Then, each of the internal network bypass switch and the external network bypass switch may be controlled depending on the control process thereof.

Here, when both the whitelists for the internal network bypass switch and the external network bypass switch are whitelists for supporting conditional two-way communication, the switch operation mode may be set to an exclusive operation mode.

Accordingly, devices allowed to communicate data in the internal network and the external network are set in advance so that access from anonymous devices is prevented, whereby a security threat may be reduced.

According to an alternative embodiment, in the apparatus 100 for supporting data communication between separate networks, the intermediate connection module checks at least one of whether intermediate data include malicious code, whether the integrity of intermediate data is maintained, and whether intermediate data are infected with viruses, and may then send intermediate data that pass the checking.

For example, when data to be sent from the external network 220 to the internal network 210 are temporarily stored and managed in the intermediate connection module through the second one-way communication, the intermediate connection module may check the received intermediate data, and may then send only data that pass the checking to the internal network 210 through the first one-way communication.

Accordingly, security may be improved by checking data in advance while being transmitted. Particularly, even if data to be transmitted from the external network to the internal network are infected with malicious code or the like, the intermediate connection device that is not directly connected with the internal network receives and checks the data in advance, whereby the data may be processed so as to be separate from the internal network, which is required to be protected for security.

According to an alternative embodiment, in the apparatus 100 for supporting data communication between separate networks, the intermediate connection module may request two-way communication with the external network connection module when the second one-way communication is enabled by the external network bypass switch, when the first one-way communication is disabled by the internal network bypass switch, or periodically.

Here, if the external network bypass switch cannot be activated even though the intermediate connection module requests two-way communication with the external network connection module, the two-way communication between the intermediate connection module and the external network connection module may not be established.

For example, when the internal network bypass switch is deactivated and the internal network bypass switch sends a control signal having the value ‘1’ to the external network bypass switch, the external network bypass switch can be activated. Also, because the first one-way communication is disabled, the intermediate connection module may enable the second one-way communication through the external network bypass switch by sending a request to enable the second one-way communication.

The internal network 210 means a separate network that limitedly communicates with another separate network via the apparatus 100 for supporting data communication between separate networks in order to provide communication security.

For example, the internal network 210 may be an intranet used in companies, schools and the like.

The external network 220 means a network that is separate from the internal network 210.

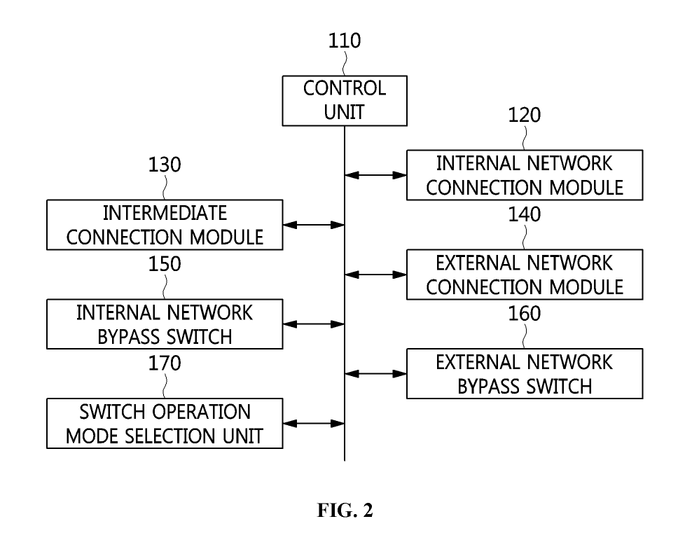

FIG. 2 is a block diagram that shows an example of the apparatus 100 for supporting data communication between separate networks, illustrated in FIG. 1.

Referring to FIG. 2, the apparatus 100 for supporting data communication between separate networks according to an embodiment of the present invention includes a control unit 110, an internal network connection module 120, an intermediate connection module 130, an external network connection module 140, an internal network bypass switch 150, an external network bypass switch 160, a switch operation mode selection unit 170, and the like.

Specifically, the control unit 110 is a kind of central processing unit, and controls the overall process for supporting data communication between separate networks. That is, the control unit 110 may provide various functions by controlling the internal network connection module 120, the intermediate connection module 130, the external network connection module 140, the internal network bypass switch 150, the external network bypass switch 160, the switch operation mode selection unit 170, and the like.

Here, the control unit 110 may include all kinds of devices capable of processing data, such as a processor and the like. Here, a ‘processor’ may indicate, for example, a data-processing device embedded in hardware, which has a circuit physically structured for performing functions represented as code or instructions included in a program. An example of such a data-processing device embedded in hardware may include processing devices such as a microprocessor, a central processing unit (CPU), a processor core, a multiprocessor, an application-specific integrated circuit (ASIC), a field-programmable gate array (FPGA), and the like, but the present invention is not limited thereto.

The internal network connection module 120 bidirectionally communicates with the internal network (210 in FIG. 1) by being interconnected therewith, and communicates with the intermediate connection module 130 through one-way communication from the internal network connection module 120 to the intermediate connection module 130 and through first one-way communication from the intermediate connection module 130 to the internal network connection module 120, which is controlled using the internal network bypass switch 150.

That is, the internal network connection module 120 is located between the internal network (210 in FIG. 1) and the intermediate connection module 130.

Here, the internal network connection module 120, the intermediate connection module 130, and the external network connection module 140 may be configured so as to be physically separate from each other.

Here, using information about a link-up event or a link-down event of an interface unidirectionally connected with the internal network bypass switch 150, the internal network connection module 120 may be aware of whether the first one-way communication is enabled or disabled or whether the first one-way communication is established or blocked.

For example, when the bypass connection of the internal network bypass switch 150 is enabled and the internal network bypass switch 150 is set to a power ON state, a link-up event occurs in the internal network connection module 120. Conversely, when the bypass connection is disabled or the internal network bypass switch 150 is set to a power OFF state, a link-down event occurs in the internal network connection module 120.

Here, it is possible to transmit data from the internal network connection module 120 to the intermediate connection module 130, but data transmission from the intermediate connection module 130 to the internal network connection module 120 is possible only through the first one-way communication, which is controlled by the internal network bypass switch 150.

Here, data transmission from the internal network connection module 120 to the intermediate connection module 130 may be performed by sending network signals over a physical one-way Ethernet link.

Here, the first one-way communication from the intermediate connection module 130 to the internal network connection module 120 may be performed by sending network signals over a physical one-way Ethernet link, but the network signals being transmitted may be delivered or dropped under the control of the internal network bypass switch 150.

That is, the internal network connection module 120 may unidirectionally or bidirectionally communicate with the intermediate connection module 130 under the control of the internal network bypass switch 150.

In an alternative embodiment, the internal network connection module 120 may send a control signal to the internal network bypass switch 150 in order to control the internal network bypass switch 150.

That is, the internal network connection module 120 may control the internal network bypass switch 150.

Here, the control signal, which is a one bit signal having the value ‘0’ or ‘1’, may be transmitted from the internal network connection module 120 to the internal network bypass switch 150 using a diode connected therebetween, and may be prevented from being transmitted in the reverse direction.

For example, the internal network connection module 120 may deactivate the internal network bypass switch 150 by sending a control signal having the value ‘0’ thereto. Also, the internal network connection module 120 may activate the internal network bypass switch 150 by sending a control signal having the value ‘1’ thereto.

Here, the internal network bypass switch 150 may be controlled based on the start and the end of two-way traffic initiated from the internal network (210 in FIG. 1).

For example, when the internal network connection module 120 receives a TCP SYN packet, configured with the 5-tuple (a source IP address, a source port number, a destination IP address, a destination port number, and a protocol in use) and initiated by any one of the internal network devices (210a to 210c in FIG. 1), which means the start of a TCP session, the internal network connection module 120 may request the internal network bypass switch 150 to enable a bypass connection and to set a power ON state. Similarly, when the internal network connection module 120 receives a TCP FIN packet for the termination of the established TCP session, the internal network connection module 120 may request the internal network bypass switch 150 to disable a bypass connection and to set a power OFF state after a certain time period (for example, one second later).

In an alternative embodiment, the internal network connection module 120 may send a control signal to the external network bypass switch 160 in order to control the external network bypass switch 160.

That is, the internal network connection module 120 may control the external network bypass switch 160.

Here, the control signal, which is a one-bit signal having the value ‘0’ or ‘1’, may be transmitted from the internal network connection module 120 to the external network bypass switch 160 using a diode connected therebetween, and may be prevented from being transmitted in the reverse direction.

For example, the internal network connection module 120 may deactivate the external network bypass switch 160 by sending a control signal having the value ‘0’ thereto. Also, the internal network connection module 120 may activate the external network bypass switch 160 by sending a control signal having the value ‘1’ thereto.

Here, when a switch operation mode selected in the switch operation mode selection unit 170 is an exclusive operation mode, the internal network connection module 120 may send two different control signals respectively to the internal network bypass switch 150 and the external network bypass switch 160, whereby the first one-way communication and the second one-way communication are not enabled at the same time.

That is, when the first one-way communication is enabled, the second one-way communication is disabled, and when the second one-way communication is enabled, the first one-way communication is disabled. Accordingly, the first one-way communication and the second one-way communication are not enabled at the same time, whereby a two-way simultaneous connection between the internal network (210 in FIG. 1) and the external network (220 in FIG. 1) may be physically prevented.

In an alternative embodiment, the internal network connection module 120 may determine whether to communicate with external network devices (220a to 220c in FIG. 1), which are connected to the external network (220 in FIG. 1), using a whitelist, and may control the internal network bypass switch 150 and the external network bypass switch 160 based thereon.

Here, a whitelist for the internal network bypass switch 150 may differ from a whitelist for the external network bypass switch 160, and the whitelists are not limited to being the same as each other.

Here, each of the whitelists may include the IP addresses and the port numbers of internal network devices (210a to 210c in FIG. 1) connected to the internal network (210 in FIG. 1), the IP addresses and the port numbers of external network devices (220a to 220c in FIG. 1) connected to the external network (220 in FIG. 1), a communication protocol, information about whether two-way communication is available, the number of times communication is allowed during a day, the number of times communication is performed during a day, the length of time available for communication, and the like.

For example, when the whitelist for the internal network bypass switch 150 includes information about one-way UDP communication from the internal network device (210a in FIG. 1) to the external network device (220a in FIG. 1), data transmission from the internal network device (210a in FIG. 1) to the external network device (220a in FIG. 1) may be allowed, but the internal network bypass switch 150 may be deactivated in order to prevent data transmission from the external network device (220a in FIG. 1) to the internal network device (210a in FIG. 1). Similarly, when the whitelist for the external network bypass switch 160 includes information about one-way UDP communication from the internal network device (210a in FIG. 1) to the external network device (220a in FIG. 1), data transmission from the internal network device (210a in FIG. 1) to the external network device (220a in FIG. 1) may be allowed, but the external network bypass switch 160 may be deactivated in order to prevent data transmission from the external network device (220a in FIG. 1) to the internal network device (210a in FIG. 1).

Here, each of the whitelists may be a whitelist for supporting conditional two-way communication by allowing data transmission from the internal network device (210a in FIG. 1) to the external network device (220a in FIG. 1) and by temporarily allowing data transmission from the external network device (220a in FIG. 1) to the internal network device (210a in FIG. 1) only when a two-way communication protocol session initiated by the internal network device (210a in FIG. 1) is present.

For example, when both the whitelists for the internal network bypass switch 150 and the external network bypass switch 160 are whitelists for supporting conditional two-way communication and when two-way communication between the internal network device (210a in FIG. 1) and the external network device (220a in FIG. 1) is allowed based thereon, each of the internal network bypass switch 150 and the external network bypass switch 160 may operate in order to temporarily allow two-way communication only when a two-way communication protocol session corresponding thereto is present. Then, each of the internal network bypass switch 150 and the external network bypass switch 160 may be controlled depending on the control process thereof.

Here, when both the whitelists for the internal network bypass switch and the external network bypass switch are whitelists for supporting conditional two-way communication, the switch operation mode may be set to an exclusive operation mode.

Here, when the internal network connection module 120 receives an Address Resolution Protocol (ARP) request packet from the internal network (210 in FIG. 1), if the target IP address in the ARP request packet matches the destination IP address of a certain entry in the selected whitelist, the internal network connection module 120 creates an ARP response packet in place of a device at the destination IP address and sends the ARP response packet to the internal network (210 in FIG. 1). That is, the internal network connection module 120 may function as an ARP proxy in place of a device at the destination IP address.

Accordingly, devices allowed to communicate data in the internal network and the external network are set in advance so that access from anonymous devices is prevented, whereby a security threat may be reduced.

In an alternative embodiment, the internal network connection module 120 may directly send data of the internal network devices (210a to 210c in FIG. 1) to the external network devices (220a to 220c in FIG. 1) through one-way communication from the internal network connection module 120 to the external network connection module 140, rather than via the intermediate connection module 130.

Here, the internal network devices (210a to 210c in FIG. 1) are always allowed to send one-way data to the external network devices (220a to 220c in FIG. 1) based on UDP.

For example, when any one of the internal network devices (210a to 210c in FIG. 1) sends monitoring data to any one of the external network devices (220a to 220c in FIG. 1) based on one-way UDP, the internal network device (i.e. one of 210a to 210c in FIG. 1) sends a UDP packet to the internal network connection module 120 through a general routing process and an ARP process, the UDP packet is forwarded from the internal network connection module 120 to the intermediate connection module 130 and to the external network connection module 140 in sequence, and the external network connection module 140 delivers the received one-way UDP packet to the corresponding external network device (i.e. one of 220a to 220c in FIG. 1).

The intermediate connection module 130 temporarily stores and manages intermediate data that are received from the internal network connection module 120 through one-way communication. Also, the intermediate connection module 130 temporarily stores and manages intermediate data that are received from the external network connection module 140 through the second one-way communication.

That is, the intermediate connection module 130 is a device located between the internal network connection module 120 and the external network connection module 140 in order to relay data that are transmitted from the internal network (210 in FIG. 1) or data that the internal network (210 in FIG. 1) needs to receive.

Here, the intermediate connection module 130 may be connected with the internal network connection module 120 and the external network connection module 140 using network switches.

Here, the intermediate connection module 130 may be aware of whether the second one-way communication is enabled or disabled or whether the second one-way communication is established or blocked using information about a link-up event or a link-down event of an interface unidirectionally connected with the external network bypass switch 160.

Here, the intermediate connection module 130 may start two-way communication with the external network devices (220a to 220c in FIG. 1) periodically, when a two-way connection with the internal network connection module 120 is terminated, or upon receiving a two-way connection allowance message from the external network bypass switch 160.

Here, the intermediate connection module 130 may bidirectionally communicate with the external network devices (220a to 220c in FIG. 1) in order to forward data, received from the internal network devices (210a to 210c in FIG. 1) and stored therein, to the external network devices (220a to 220c in FIG. 1), or in order to receive data from the external network devices (220a to 220c in FIG. 1) and store the same therein. If any one of the internal network devices (210a to 210c in FIG. 1) attempts to establish a two-way session with the intermediate connection module 130, the session between the intermediate connection module 130 and the external network devices (220a to 220c in FIG. 1) may be unexpectedly terminated.

Here, like the internal network connection module 120, the intermediate connection module 130 may send an ARP response packet in place of the internal network devices (210a to 210c in FIG. 1). To this end, the intermediate connection module 130 may retain a proxy ARP table that includes a sender's IP address, a sender's Media Access Control (MAC) address, and a destination IP address.

In an alternative embodiment, the intermediate connection module 130 may check at least one of whether intermediate data include malicious code, whether the integrity of intermediate data is maintained, and whether intermediate data are infected with viruses, and may then send only intermediate data that pass the checking.

For example, when data to be sent from the external network (220 in FIG. 1) to the internal network (210 in FIG. 1) are temporarily stored and managed in the intermediate connection module 130 through the second one-way communication, the intermediate connection module 130 may check the received intermediate data, and may send only data that pass the checking to the internal network (210 in FIG. 1) via the internal network connection module 120 through the first one-way communication.

Accordingly, security may be improved by checking data in advance while being transmitted. Particularly, even if data to be sent from the external network to the internal network are infected with malicious code or the like, the intermediate connection device, which is not directly connected with the internal network, receives and checks the data in advance, whereby the data may be processed so as to be separate from the internal network that is required to be protected for security.

In an alternative embodiment, the intermediate connection module 130 may request two-way communication with the external network connection module 140 when the second one-way communication is enabled by the external network bypass switch 160, when the first one-way communication is disabled by the internal network bypass switch 150, or periodically.

Here, if the external network bypass switch 160 cannot be activated even though the intermediate connection module 130 requests two-way communication with the external network connection module 140, two-way communication between the intermediate connection module 130 and the external network connection module 140 may not be established.

For example, when the internal network bypass switch 150 is deactivated and sends a control signal having the value ‘1’ to the external network bypass switch 160, the external network bypass switch 160 can be activated. Also, because the first one-way communication is disabled, the intermediate connection module 130 may enable the second one-way communication through the external network bypass switch 160 by sending a request to enable the second one-way communication.

The external network connection module 140 bidirectionally communicates with the external network (220 in FIG. 1) by being interconnected therewith, and communicates with the intermediate connection module 130 through one-way communication from the intermediate connection module 130 to the external network connection module 140 and through the second one-way communication from the external network connection module 140 to the intermediate connection module 130, which is controlled by the external network bypass switch 160.

That is, the external network connection module 140 is located between the external network (220 in FIG. 1) and the intermediate connection module 130.

Here, it is possible to transmit data unidirectionally from the intermediate connection module 130 to the external network connection module 140, but data transmission from the external network connection module 140 to the intermediate connection module 130 is possible only through the second one-way communication, which is controlled by the external network bypass switch 160.

Here, data transmission from the intermediate connection module 130 to the external network connection module 140 may be performed by sending network signals over a physical one-way Ethernet link.

Here, the second one-way communication from the external network connection module 140 to the intermediate connection module 130 may be performed by sending network signals over a physical one-way Ethernet link, but the network signals being transmitted may be delivered or dropped under the control of the external network bypass switch 160.

That is, the external network connection module 140 may unidirectionally or bidirectionally communicate with the intermediate connection module 130 under the control of the external network bypass switch 160.

Here, like the internal network connection module 120, the external network connection module 140 may send an ARP response packet in place of the internal network devices (210a to 210c in FIG. 1). To this end, the external network connection module 140 may retain a proxy ARP table that includes a sender's IP address, a sender's MAC address, and a destination IP address.

The internal network bypass switch 150 is a switch for controlling the first one-way communication from the intermediate connection module 130 to the internal network connection module 120. The switch may be an analog multiplexer/demultiplexer switch, such as an FSAL200 or the like, but the kind of switch is not limited thereto.

Here, the internal network bypass switch 150 may forward or drop a network signal being transmitted through the first one-way communication.

In an alternative embodiment, the internal network bypass switch 150 may control the first one-way communication using at least one of enabling/disabling a bypass connection and enabling/disabling the supply of power.

That is, the internal network bypass switch 150 may selectively use enabling/disabling a bypass connection or enabling/disabling the supply of power, or may control the first one-way communication using both of them.

For example, when the bypass connection of the internal network bypass switch 150 is disabled and when the supply of power thereto is interrupted, a network signal being transmitted through the first one-way communication may be dropped en route, but when the bypass connection of the internal network bypass switch 150 is enabled and when power is supplied thereto, the network signal being transmitted through the first one-way communication may be forwarded.

In an alternative embodiment, the internal network bypass switch 150 may send a control signal to the external network bypass switch 160 in order to control the external network bypass switch 160.

That is, the internal network bypass switch 150 may control the external network bypass switch 160, whereby the external network bypass switch 160 may be made to operate in conjunction with the operation of the internal network bypass switch 150.

Here, the control signal, which is a one-bit signal having the value ‘0’ or ‘1’, may be transmitted from the internal network bypass switch 150 to the external network bypass switch 160 using a diode connected therebetween, and may be prevented from being transmitted in the reverse direction.

For example, when the internal network bypass switch 150 is activated and the first one-way communication is established, the external network bypass switch 160 may be deactivated by sending a control signal having the value ‘0’ thereto. Also, when the internal network bypass switch 150 is deactivated and the first one-way communication is interrupted, the external network bypass switch 160 may be activated by sending a control signal having the value ‘1’ thereto.

Here, the control signal having the value ‘1’, transmitted to the external network bypass switch 160, may be used as an instruction to activate the external network bypass switch 160, but may alternatively be used to indicate that the external network bypass switch 160 can be activated.

For example, when it is found, using the control signal having the value ‘1’ transmitted to the external network bypass switch 160, that the external network bypass switch 160 can be activated, the external network bypass switch 160 is activated only when the second one-way communication is required. That is, even though the internal network bypass switch 150 is deactivated, the external network bypass switch 160 may be activated only when it receives a request to make a two-way session from the intermediate connection module 130.

In an alternative embodiment, if a switch operation mode selected in the switch operation mode selection unit 170 is an exclusive operation mode, when the first one-way communication is established or enabled, the internal network bypass switch 150 may interrupt or disable the second one-way communication by sending a control signal to the external network bypass switch 160.

That is, because the first one-way communication and the second one-way communication cannot be simultaneously enabled by disabling the second one-way communication when the first one-way communication is enabled, a two-way simultaneous connection between the internal network (210 in FIG. 1) and the external network (220 in FIG. 1) may be physically prevented.

Here, when the switch operation mode is an exclusive operation mode, the internal network bypass switch 150 may send the external network bypass switch 160 a control signal that is contrary to the control signal received from the internal network connection module 120. In this case, the internal network bypass switch 150 always operates counter to the operation of the external network bypass switch 160.

Accordingly, even if the internal network connection module 120 tampers with a control signal to be transmitted to the internal network bypass switch 150 because the internal network connection module 120 is infected with malicious code or the like over a network, it is impossible for both the internal network bypass switch 150 and the external network bypass switch 160 to enable their bypass connections and to become a power ON state at the same time. Accordingly, the end-to-end two-way connection between the internal network and the external network may be physically prevented, whereby an internal network device may be prevented from being controlled in real time by an external attacker even though the internal network device is infected with a backdoor.

The external network bypass switch 160 is a switch for controlling the second one-way communication from the external network connection module 140 to the intermediate connection module 130. The switch may be an analog multiplexer/demultiplexer switch, such as an FSAL200 or the like, but the kind of switch is not limited thereto.

Here, the external network bypass switch 160 may forward or drop a network signal being transmitted through the second one-way communication.

Here, the external network bypass switch 160 may send a message for announcing the start of allowance of two-way communication or the end thereof to the intermediate connection module 130 when a link-up event or a link-down event occurs.

In an alternative embodiment, the external network bypass switch 160 may control the second one-way communication using at least one of enabling/disabling a bypass connection and enabling/disabling the supply of power.

That is, the external network bypass switch 160 may selectively use enabling/disabling a bypass connection or enabling/disabling the supply of power, or may control the second one-way communication using both of them.

For example, when the bypass connection of the external network bypass switch 160 is disabled and when the supply of power thereto is interrupted, a network signal being transmitted through the second one-way communication may be dropped en route, but when the bypass connection of the external network bypass switch 160 is enabled and when power is supplied thereto, the network signal being transmitted through the second one-way communication may be forwarded.

The switch operation mode selection unit 170 selects a switch operation mode for the internal network bypass switch 150 and the external network bypass switch 160.

Here, the switch operation mode selection unit 170 may select the switch operation mode for the internal network bypass switch 150 and the external network bypass switch 160 depending on user input.

Here, the switch operation mode selection unit 170 may enable the selection of the switch operation mode by being implemented as a physical switch, a physical button, or a physical selector.

Here, the switch operation mode may include an exclusive operation mode.

Here, the exclusive operation mode causes the internal network bypass switch 150 and the external network bypass switch 160 to operate in a mutually exclusive manner.

For example, when the switch operation mode is an exclusive operation mode, if the internal network bypass switch 150 is activated, the external network bypass switch 160 may be deactivated, but if the internal network bypass switch 150 is deactivated, the external network bypass switch 160 may be activated.

Here, when the switch operation mode is a synchronous operation mode, the internal network bypass switch and the external network bypass switch are caused to operate synchronously, whereby both the internal network connection module and the external network connection module may operate as two-way communication devices at the same time.

For example, when the switch operation mode is a synchronous operation mode, if the internal network bypass switch is deactivated, the external network bypass switch may be deactivated, and if the internal network bypass switch is activated, the external network bypass switch may be activated.

Accordingly, the internal network bypass switch and the external network bypass switch may operate in a mutually exclusive manner using the exclusive operation mode as the switch operation mode, whereby the first one-way communication and the second one-way communication are not established at the same time. That is, a two-way simultaneous connection between the internal network and the external network may be prevented.

In an alternative embodiment, the apparatus 100 for supporting data communication between separate networks may deliver information about one or more of the switch operation mode, the internal network bypass switch 150, and the external network bypass switch 160 to a management software console or the like.

Here, the management software may determine whether a system is operating normally based on the received information.

For example, when the switch operation mode is an exclusive operation mode, if both the internal network bypass switch 150 and the external network bypass switch 160 are activated, the management software may provide an error alarm and deactivate the external network bypass switch 160.

Accordingly, the apparatus for supporting data communication between separate networks may prevent a problem caused due to unexpected operation.

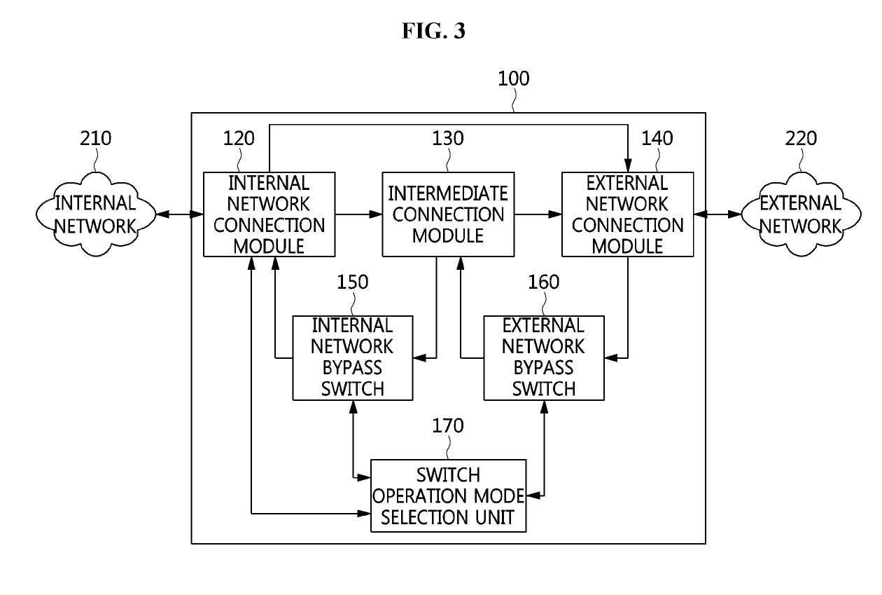

FIG. 3 is a block diagram that shows an example of the relationship between the components of the apparatus 100 for supporting data communication between separate networks, illustrated in FIG. 2.

Referring to FIG. 3, the apparatus 100 for supporting data communication between separate networks illustrated in FIG. 2 is configured such that the internal network connection module 120 is interconnected with the internal network 210, and such that the external network connection module 140 is interconnected with the external network 220.

Here, the internal network connection module 120 may transmit data unidirectionally therefrom to the intermediate connection module 130 or to the external network connection module 140.

Here, the intermediate connection module 130 may transmit data unidirectionally therefrom to the external network connection module 140.

Here, the intermediate connection module 130 may transmit data therefrom to the intermediate connection module 120 via the internal network bypass switch 150 through first one-way communication.

That is, the first one-way communication may be established or interrupted under the control of the internal network bypass switch 150.

Here, the internal network connection module 120 may control the state of the internal network bypass switch 150 by sending a control signal thereto.

Here, the external network connection module 140 may transmit data therefrom to the intermediate connection module 130 via the external network bypass switch 160 through second one-way communication.

That is, the second one-way communication may be established or interrupted under the control of the external network bypass switch 160.

Here, the operation of the internal network bypass switch 150 and the external network bypass switch 160 may be determined depending on a switch operation mode selected in the switch operation mode selection unit 170.

For example, when the switch operation mode is an exclusive operation mode, the internal network bypass switch 150 and the external network bypass switch 160 may operate in a mutually exclusive manner.

Here, the internal network bypass switch 150 may control the state of the external network bypass switch 160 by sending a control signal thereto.

Here, the internal network connection module 120 may control the state of the external network bypass switch 160 by sending a control signal thereto.

In FIG. 3, for clarity of description, each of communication between the internal network connection module 120 and the intermediate connection module 130 and communication between the intermediate connection module 130 and the external network connection module 140 has been described as being configured with two types of one-way communication having different directions, but this includes not only the use of two physically separate one-way communication channels but also the use of a two-way communication channel in which the direction of communication may be set.

Accordingly, communication between the internal network and the external network is classified into two phases based on the intermediate connection module, and one-way communication from the external network to the internal network is controlled using a bypass switch, whereby an attack from the external network to the internal network may be effectively handled.

Also, when the switch operation mode is an exclusive operation mode, because the internal network bypass switch and the external network bypass switch operate in a mutually exclusive manner, a two-way simultaneous connection between the internal network and the external network is prevented, which improves stability in response to a security threat.

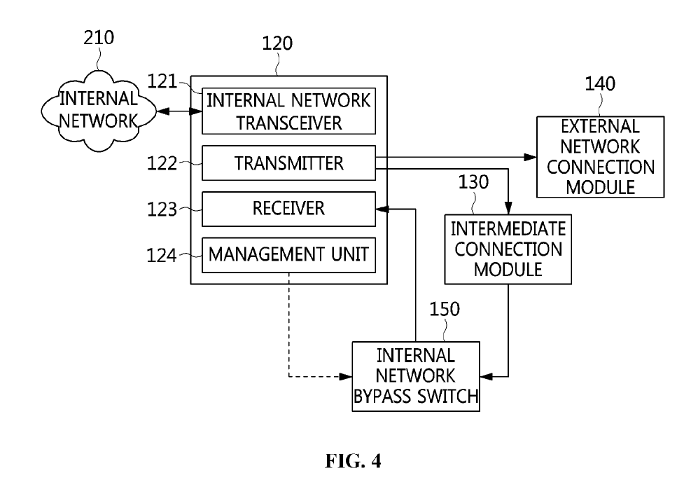

FIG. 4 is a block diagram that shows the internal network connection module 120 according to an embodiment of the present invention.

Referring to FIG. 4, the internal network connection module 120 according to an embodiment of the present invention includes an internal network transceiver 121, a transmitter 122, a receiver 123, a management unit 124, and the like.

Specifically, the internal network transceiver 121 is interconnected with the internal network 210, and sends and receives signals through two-way communication with the internal network 210.

The transmitter 122 sends data, which were sent from the internal network 210 and received by the internal network transceiver 121, in the form of signals to the intermediate connection module 130 or to the external network connection module 140 through one-way communication. Here, the transmitter 122 physically supports only transmission.

The receiver 123 receives a signal from the intermediate connection module 130 via the internal network bypass switch 150. Here, the receiver 123 physically supports only reception.

Here, the one-way signal being transmitted from the intermediate connection module 130 to the receiver 123 may be delivered or blocked under the control of the internal network bypass switch 150.

The management unit 124 functions to manage the overall process in the internal network connection module 120, and may send a control signal for controlling the internal network bypass switch 150 over a signal line.

Here, the signal line over which a control signal for controlling the internal network bypass switch 150 is transmitted is a line for transmitting a one-bit signal having the value ‘0’ or ‘1’, and may be implemented so as to make the signal be transmitted only in one direction using a diode.

Although not illustrated in FIG. 4, the management unit 124 may send a control signal for controlling the external network bypass switch 160 over a signal line.

Here, the signal line over which a control signal for controlling the external network bypass switch 160 is transmitted is a line for transmitting a one-bit signal having the value ‘0’ or ‘1’, and may be implemented so as to make the signal be transmitted only in one direction using a diode.

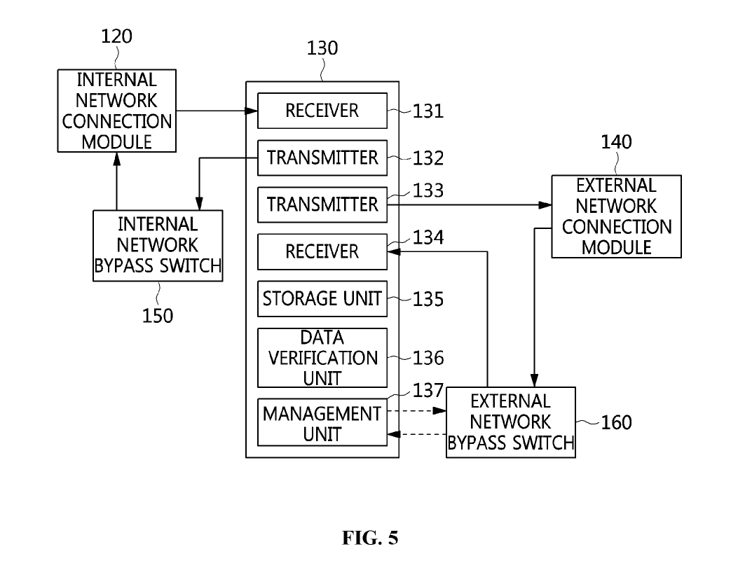

FIG. 5 is a block diagram that shows the intermediate connection module 130 according to an embodiment of the present invention.

Referring to FIG. 5, the intermediate connection module 130 according to an embodiment of the present invention includes a first receiver 131, a first transmitter 132, a second transmitter 133, a second receiver 134, a storage unit 135, a data verification unit 136, a management unit 137, and the like.

Specifically, the first receiver 131 receives a signal, to be transmitted to the external network connection module 140, from the internal network connection module 120 through one-way communication. Here, the first receiver 131 physically supports only reception.

The first transmitter 132 sends a signal, received from the external network connection module 140, to the internal network connection module 120 via the internal network bypass switch 150 through one-way communication. Here, the first transmitter 132 physically supports only transmission.

The second transmitter 133 transmits a signal, received from the internal network connection module 120, to the external network connection module 140 through one-way communication. Here, the second transmitter 133 physically supports only transmission.

The second receiver 134 receives a signal from the external network connection module 140 via the external network bypass switch 160. Here, the second receiver 134 physically supports only reception.

The storage unit 135 temporarily stores data received from the internal network connection module 120 or data received from the external network connection module 140.

The data verification unit 136 checks data received from the internal network connection module 120 or data received from the external network connection module 140.

Here, the data verification unit 136 may check at least one of whether data to be checked include malicious code, the integrity of the data, and whether the data are infected with viruses.

The management unit 137 functions to manage the overall process in the intermediate connection module 130, and may receive information about the state of the external network bypass switch 160 therefrom over a signal line.

Here, the signal line over which information about the state of the external network bypass switch 160 is transmitted is a line for transmitting a one-bit signal having the value ‘0’ or ‘1’, and may be implemented so as to make the signal be transmitted only in one direction using a diode.

Here, the management unit 137 may send a signal for requesting a two-way session to the external network bypass switch 160.

Here, a signal line over which a signal for requesting a two-way session is transmitted to the external network bypass switch 160 is a line for transmitting a one-bit signal having the value ‘0’ or ‘1’, and may be implemented so as to make the signal be transmitted only in one direction using a diode.

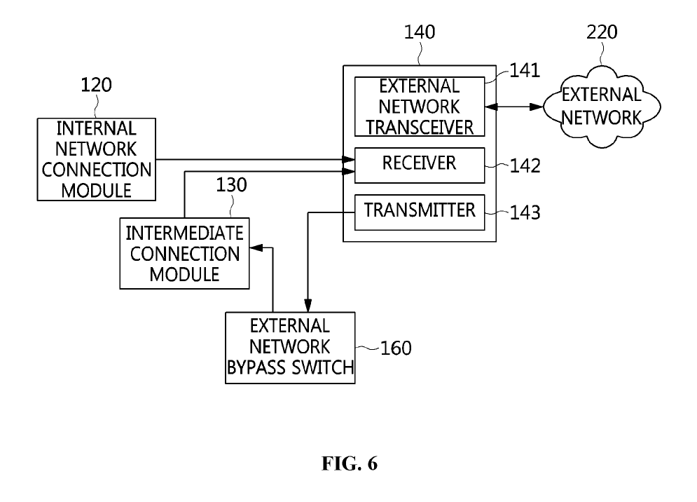

FIG. 6 is a block diagram that shows the external network connection module 140 according to an embodiment of the present invention.

Referring to FIG. 6, the external network connection module 140 according to an embodiment of the present invention includes an external network transceiver 141, a receiver 142, a transmitter 143, and the like.

Specifically, the external network transceiver 141 is interconnected with the external network 220, and sends and receives signals through two-way communication with the external network 220.

The receiver 142 receives signals from the internal network connection module 120 or the intermediate connection module 130 through one-way communication. Here, the receiver 142 physically supports only reception.

The transmitter 143 sends a signal to the intermediate connection module 130 via the external network bypass switch 160. Here, the transmitter 143 physically supports only transmission.

Here, the signal transmitted from the transmitter 143 to the intermediate connection module 130 through one-way communication may be delivered or blocked under the control of the external network bypass switch 160.

Here, the external network bypass switch 160 may be controlled using a control signal transmitted from the internal network connection module 120 or from the internal network bypass switch 150.

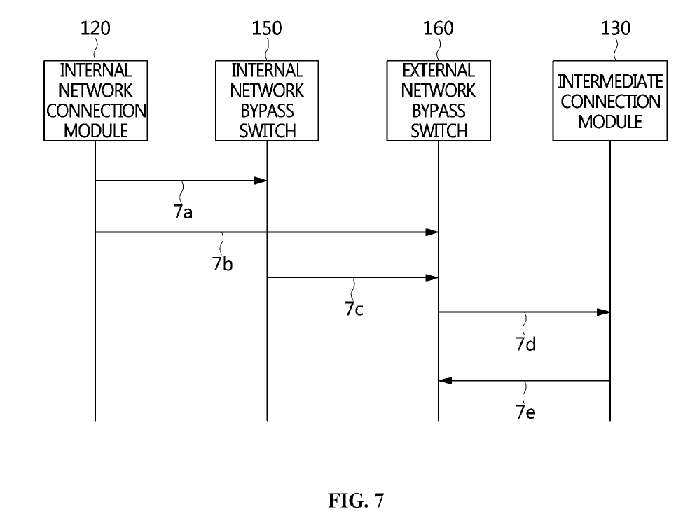

FIG. 7 is a view that shows signal transmission lines used in the apparatus (100 in FIG. 1) for supporting data communication between separate networks according to an embodiment of the present invention.

Referring to FIG. 7, the signal transmission lines 7a, 7b, 7c, 7d and 7e of the apparatus (100 in FIG. 1) for supporting data communication between separate networks according to an embodiment of the present invention may be configured to send signals in only one direction using respective diodes.

Also, the respective signal transmission lines 7a, 7b, 7c, 7d and 7e are lines for transmitting a one-bit signal having the value ‘0’ or ‘1’.

Here, line 1 7a is a line over which the internal network connection module 120 may send a signal for controlling the internal network bypass switch 150 thereto.

Also, line 2 7b is a line over which the internal network connection module 120 may send a signal for controlling the external network bypass switch 160 thereto.

Here, the control signal transmitted over line 2 7b may be contrary to the signal transmitted over line 1 7a.

For example, when a control signal having the value ‘1’ is transmitted over line 1 7a in order to activate the internal network bypass switch 150, a control signal transmitted over line 2 7b may be a control signal having the value ‘0’ for deactivating the external network bypass switch 160.

Also, line 3 7c is a line over which the internal network bypass switch 150 may send a signal for controlling the external network bypass switch 160 thereto.

Here, the control signal transmitted over line 3 7c may be contrary to the signal transmitted over line 1 7a.

For example, when a control signal having the value ‘1’ is transmitted over line 1 7a in order to activate the internal network bypass switch 150, a control signal transmitted over line 3 7c may be a control signal having the value ‘0’ for deactivating the external network bypass switch 160.

Also, line 4 7d is a line over which the external network bypass switch 160 transmits a signal indicating the state thereof to the intermediate connection module 130.

Also, line 5 7e is a line over which the intermediate connection module 130 sends a request for a two-way session to the external network bypass switch 160.

Here, even though the external network bypass switch 160 is activated, a two-way session between the intermediate connection module 130 and the external network connection module 140 may be established not immediately but when there is a request for the two-way session using a signal transmitted over line 5 7e.

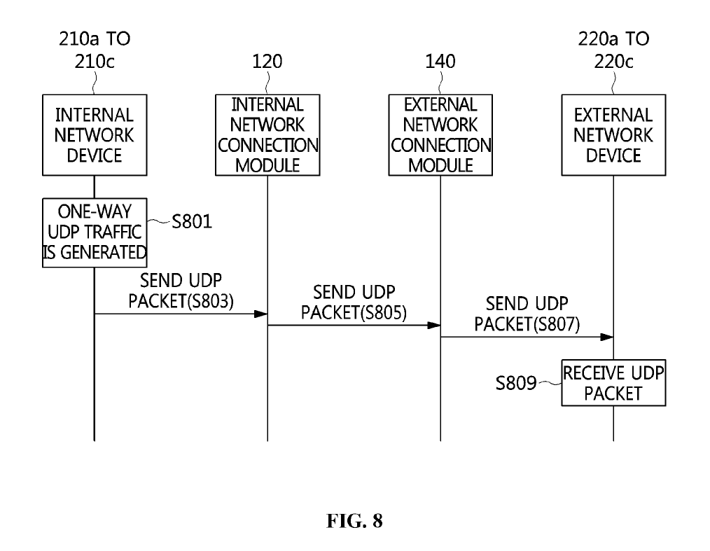

FIG. 8 is a view that shows a method for transmitting one-way UDP data from an internal network device to an external network device according to an embodiment of the present invention.

Referring to FIG. 8, in the method for transmitting one-way UDP data from an internal network device to an external network device according to an embodiment of the present invention, one-way UDP traffic is generated in any one of internal network devices 210a to 210c at step S801.

Also, in the method for transmitting one-way UDP data from an internal network device to an external network device according to an embodiment of the present invention, the internal network device (i.e. one of 210a to 210c) sends a UDP packet to the internal network connection module 120 at step S803.

Also, in the method for transmitting one-way UDP data from an internal network device to an external network device according to an embodiment of the present invention, the internal network connection module 120 sends the UDP packet to the external network connection module 140 at step S805.

Here, the internal network connection module 120 may send the UDP packet to the external network connection module 140 via the intermediate connection module (130 in FIG. 2).

Also, in the method for transmitting one-way UDP data from an internal network device to an external network device according to an embodiment of the present invention, the external network connection module 140 sends the UDP packet to an external network device (i.e. one of 220a to 220c) at step S807 and S809.

Accordingly, the internal network device may always send one-way UDP data to the external network device.

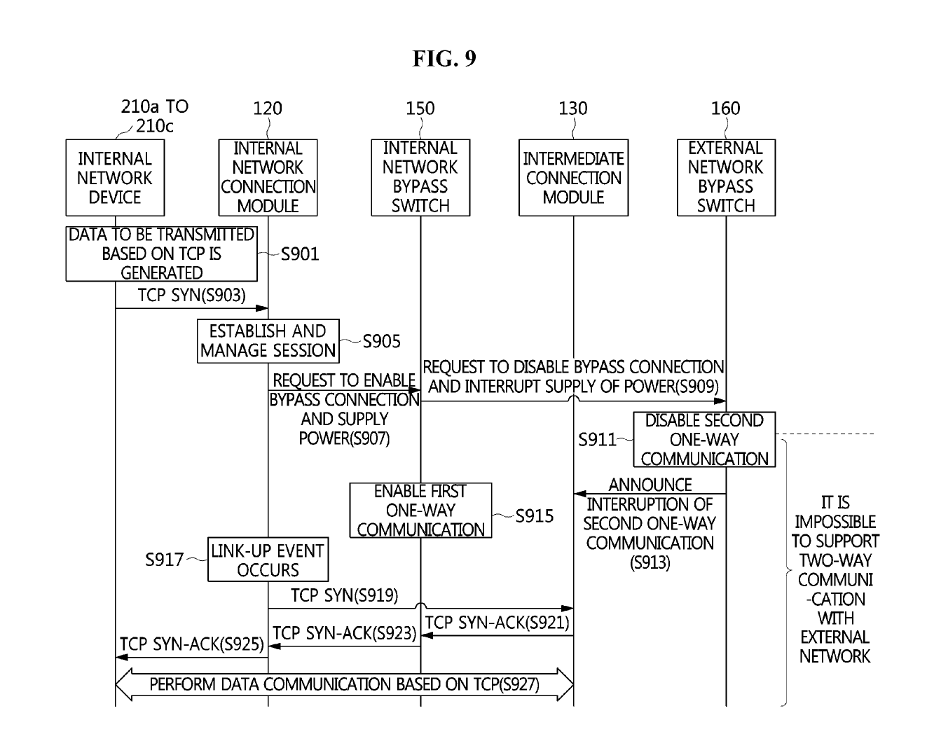

FIG. 9 is a view that shows a method for transmitting TCP data from an internal network device to an external network device according to an embodiment of the present invention.

Here, when TCP data are sent from an internal network device to an external network device, the internal network device may operate as a TCP client, and an intermediate connection module (130 in FIG. 2) may operate as a TCP server for the internal network device.

Also, the intermediate connection module (130 in FIG. 2) may operate as a TCP client for the external network device.

That is, TCP data sent by the internal network device are stored in the intermediate connection module (130 in FIG. 2), and the intermediate connection module (130 in FIG. 2) sends the TCP data to the external network device, whereby data transmission is completed.

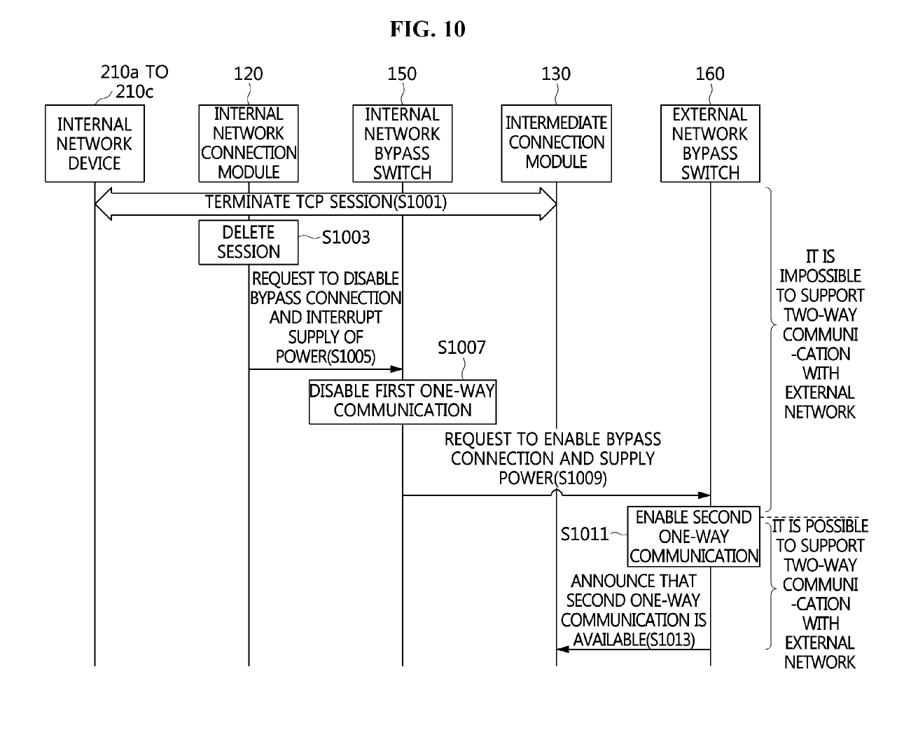

FIG. 9 and FIG. 10 show only operation processes in which the internal network device sends TCP data to the intermediate connection module (130 in FIG. 2), FIG. 9 shows the process of establishing a session for TCP data communication, and FIG. 10 shows the process of terminating the TCP data communication process after the TCP session is established.

Referring to FIG. 9, in the method for transmitting TCP data from an internal network device to an external network device according to an embodiment of the present invention, data to be transmitted based on TCP is generated in any one of internal network devices 210a to 210c at step S901.

Also, in the method for transmitting TCP data from an internal network device to an external network device according to an embodiment of the present invention, the internal network device (i.e. one of 210a to 210c) sends a TCP SYN packet to the internal network connection module at step S903.

Also, in the method for transmitting TCP data from an internal network device to an external network device according to an embodiment of the present invention, the internal network connection module 120 receives the TCP SYN packet, establishes a session, and manages the session at step S905.

Also, in the method for transmitting TCP data from an internal network device to an external network device according to an embodiment of the present invention, the internal network connection module 120 requests the internal network bypass switch 150 to enable a bypass connection and to set a power ON state at step S907.

Also, in the method for transmitting TCP data from an internal network device to an external network device according to an embodiment of the present invention, the internal network bypass switch 150 requests the external network bypass switch 160 to disable a bypass connection and to set a power OFF state at step S909.

Also, in the method for transmitting TCP data from an internal network device to an external network device according to an embodiment of the present invention, the external network bypass switch 160 interrupts second one-way communication by disabling a bypass connection and setting a power OFF state at step S911.

Also, in the method for transmitting TCP data from an internal network device to an external network device according to an embodiment of the present invention, the external network bypass switch 160 sends notification of the interruption of the second one-way communication to the intermediate connection module 130 at step S913.

Also, in the method for transmitting TCP data from an internal network device to an external network device according to an embodiment of the present invention, the internal network bypass switch 150 enables first one-way communication by enabling a bypass connection and setting a power ON state at step S915.

Also, in the method for transmitting TCP data from an internal network device to an external network device according to an embodiment of the present invention, a link-up event occurs in the internal network connection module 120 at step S917.

Also, in the method for transmitting TCP data from an internal network device to an external network device according to an embodiment of the present invention, when the link-up event occurs, the internal network connection module 120 sends the TCP SYN packet to the intermediate connection module 130 at step S919.

Also, in the method for transmitting TCP data from an internal network device to an external network device according to an embodiment of the present invention, the intermediate connection module 130 sends a TCP Synchronization-Acknowledgement (SYN-ACK) packet to the internal network connection module 120 via the internal network bypass switch 150 at steps S921 and S923.

Also, in the method for transmitting TCP data from an internal network device to an external network device according to an embodiment of the present invention, the internal network connection module 120 sends the TCP SYN-ACK packet to the internal network device (i.e. one of 210a to 210c) at step S925.

Also, in the method for transmitting TCP data from an internal network device to an external network device according to an embodiment of the present invention, the internal network device (i.e. one of 210a to 210c) receives the TCP SYN-ACK packet, a TCP session with the intermediate connection module 130 is established, and the internal network device (i.e. one of 210a to 210c) and the intermediate connection module 130 perform data communication based on TCP at step S927.

Here, after the second one-way communication is interrupted at step S911, two-way communication with the external network (220 in FIG. 1) cannot be supported.

FIG. 10 is a view that shows the method for transmitting TCP data from an internal network device to an external network device according to an embodiment of the present invention.

FIG. 10 shows the process of finishing TCP data communication after the process of establishing the TCP session shown in FIG. 9.

Referring to FIG. 10, in the method for transmitting TCP data from an internal network device to an external network device according to an embodiment of the present invention, when TCP communication between the internal network device (i.e. one of 210a to 210c) and the intermediate connection module 130 is finished, the process of terminating the TCP session is performed at step S1001.

Also, in the method for transmitting TCP data from an internal network device to an external network device according to an embodiment of the present invention, the internal network connection module 120 deletes the corresponding TCP session at step S1003.

Also, in the method for transmitting TCP data from an internal network device to an external network device according to an embodiment of the present invention, the internal network connection module 120 requests the internal network bypass switch 150 to disable a bypass connection and to set a power OFF state at step S1005.

Also, in the method for transmitting TCP data from an internal network device to an external network device according to an embodiment of the present invention, the internal network bypass switch 150 disables the first one-way communication by disabling a bypass connection and setting a power OFF state at step S1007.

Also, in the method for transmitting TCP data from an internal network device to an external network device according to an embodiment of the present invention, the internal network bypass switch 150 requests the external network bypass switch 160 to enable a bypass connection and to set a power ON state at step S1009.

Also, in the method for transmitting TCP data from an internal network device to an external network device according to an embodiment of the present invention, the external network bypass switch 160 enables the second one-way communication by enabling a bypass connection and setting a power ON state at step S1011.

Also, in the method for transmitting TCP data from an internal network device to an external network device according to an embodiment of the present invention, the external network bypass switch 160 sends notification of the establishment of the second one-way communication to the intermediate connection module 130 at step S1013.

Here, after the TCP session is established and TCP data communication is performed, two-way communication with the external network (220 in FIG. 1) cannot be supported before the second one-way communication is enabled at step S1011, but two-way communication with the external network (220 in FIG. 1) may be supported after the second one-way communication is enabled at step S1011.

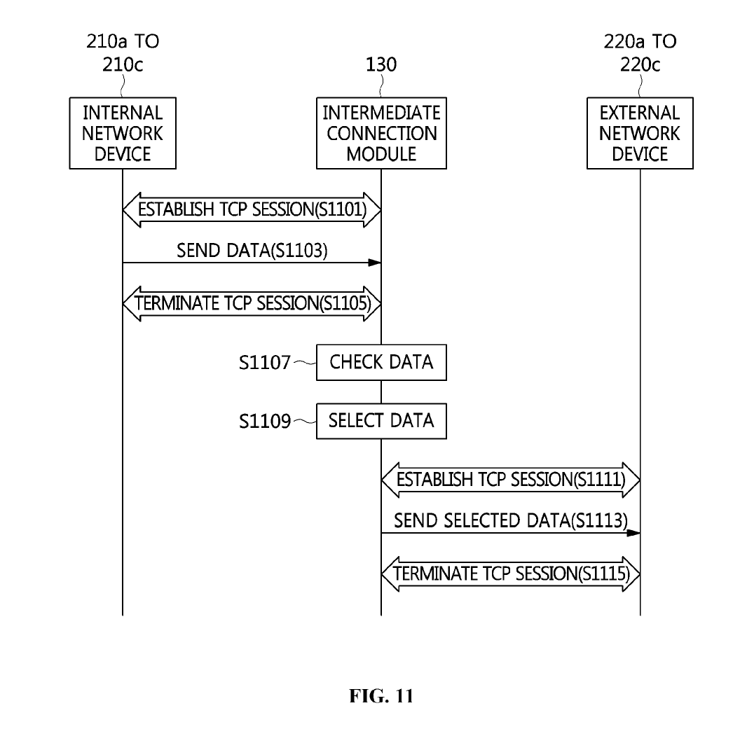

FIG. 11 is a view that shows the overall process of the method for transmitting TCP data from an internal network device to an external network device according to an embodiment of the present invention.

Referring to FIG. 11, in the method for transmitting TCP data from an internal network device to an external network device according to an embodiment of the present invention, any one of the internal network devices 210a to 210c and the intermediate connection module 130 establish a TCP session therebetween at step S1101.

Here, the establishment of the TCP session between the internal network device (i.e. one of 210a to 210c) and the intermediate connection module 130 may follow the process illustrated in FIG. 9.

Also, in the method for transmitting TCP data from an internal network device to an external network device according to an embodiment of the present invention, the internal network device (i.e. one of 210a to 210c) sends data to the intermediate connection module 130, and the intermediate connection module 130 stores the received data at step S1103.

Also, in the method for transmitting TCP data from an internal network device to an external network device according to an embodiment of the present invention, the TCP session between the internal network device (i.e. one of 210a to 210c) and the intermediate connection module 130 is terminated at step S1105.

Here, the termination of the TCP session between the internal network device (i.e. one of 210a to 210c) and the intermediate connection module 130 may follow the process illustrated in FIG. 10.

Also, in the method for transmitting TCP data from an internal network device to an external network device according to an embodiment of the present invention, the intermediate connection module 130 may check at least one of whether the received data include malicious code, whether the integrity of the received data is maintained, and whether the received data are infected with viruses at step S1107.

Also, in the method for transmitting TCP data from an internal network device to an external network device according to an embodiment of the present invention, the intermediate connection module 130 selects data that pass the checking at step S1109.

Also, in the method for transmitting TCP data from an internal network device to an external network device according to an embodiment of the present invention, the intermediate connection module 130 and one of the external network devices 220a to 220c establish a TCP session therebetween at step S1111.

Here, the TCP session between the intermediate connection module 130 and the external network device (i.e. one of 220a to 220c) may be established periodically or whenever a two-way communication allowance message is received from the external network bypass switch (160 in FIG. 2).

Also, in the method for transmitting TCP data from an internal network device to an external network device according to an embodiment of the present invention, the intermediate connection module 130 sends the selected data to the external network device (i.e. one of 220a to 220c) at step S1113.

Also, in the method for transmitting TCP data from an internal network device to an external network device according to an embodiment of the present invention, the TCP session between the intermediate connection module 130 and the external network device (i.e. one of 220a to 220c) is terminated at step S1115.

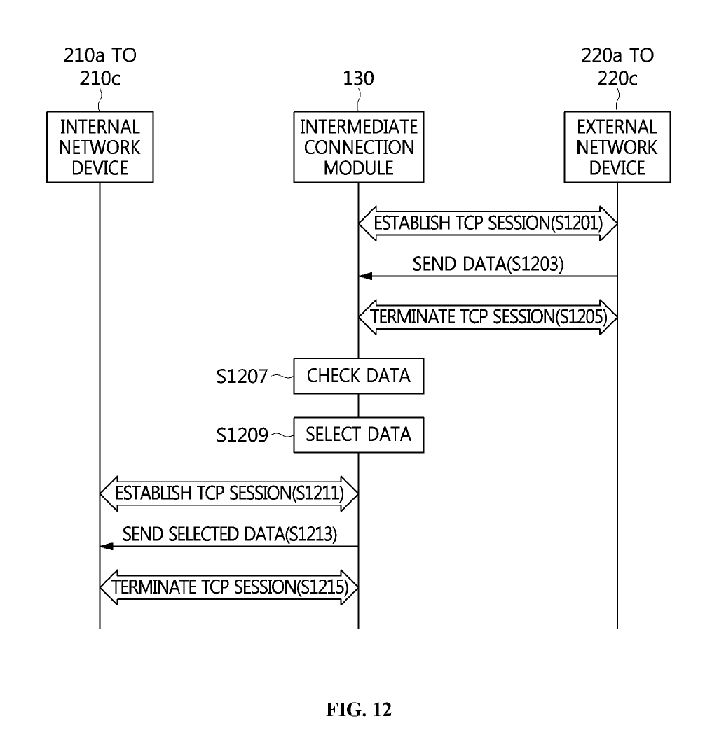

FIG. 12 is a view that shows the overall process of the method for transmitting TCP data from an external network device to an internal network device according to an embodiment of the present invention.

Referring to FIG. 12, in the method for transmitting TCP data from an external network device to an internal network device according to an embodiment of the present invention, the intermediate connection module 130 and any one of external network devices 220a to 220c establish a TCP session therebetween at step S1201.

Here, the TCP session between the intermediate connection module 130 and the external network device (i.e. one of 220a to 220c) may be established periodically or whenever a two-way communication allowance message is received from the external network bypass switch (160 in FIG. 2).

Also, in the method for transmitting TCP data from an external network device to an internal network device according to an embodiment of the present invention, the external network device (i.e. one of 220a to 220c) sends data to the intermediate connection module 130, and the intermediate connection module 130 stores the received data at step S1203.

Also, in the method for transmitting TCP data from an external network device to an internal network device according to an embodiment of the present invention, the TCP session between the intermediate connection module 130 and the external network device (i.e. one of 220a to 220c) is terminated at step S1205.

Also, in the method for transmitting TCP data from an external network device to an internal network device according to an embodiment of the present invention, the intermediate connection module 130 may check at least one of whether the received data include malicious code, whether the integrity of the received data is maintained, and whether the received data are infected with viruses at step S1207.

Also, in the method for transmitting TCP data from an external network device to an internal network device according to an embodiment of the present invention, the intermediate connection module 130 selects data that pass the checking at step S1209.

Also, in the method for transmitting TCP data from an external network device to an internal network device according to an embodiment of the present invention, the intermediate connection module 130 and one of the internal network devices 210a to 210c establish a TCP session therebetween at step S1211.

Here, the TCP session between the intermediate connection module 130 and the internal network device (i.e. one of 210a to 210c) may be established periodically or when necessary.

Also, in the method for transmitting TCP data from an external network device to an internal network device according to an embodiment of the present invention, the intermediate connection module 130 sends the selected data to the internal network device (i.e. one of 210a to 210c) at step S1213.

Also, in the method for transmitting TCP data from an external network device to an internal network device according to an embodiment of the present invention, the TCP session between the intermediate connection module 130 and the internal network device (i.e. one of 210a to 210c) is terminated at step S1215.

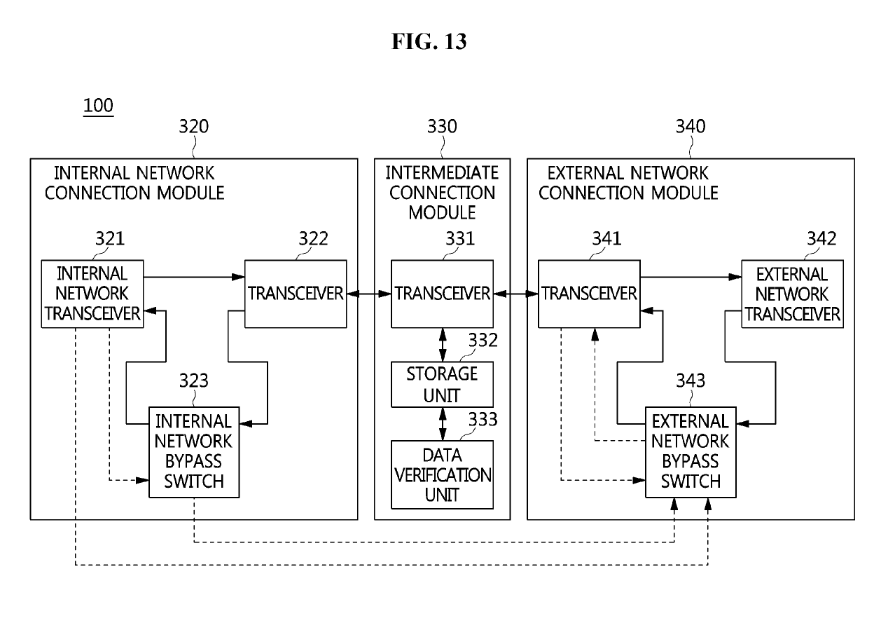

FIG. 13 is a block diagram that shows another example of the apparatus 100 for supporting data communication between separate networks illustrated in FIG. 1.

Referring to FIG. 13, the apparatus 100 for supporting data communication between separate networks illustrated in FIG. 1 includes an internal network connection module 320, an intermediate connection module 330, an external network connection module 340 and the like.

Specifically, the internal network connection module 320 bidirectionally communicates with the internal network (210 in FIG. 1) by being interconnected therewith, and the external network connection module 340 bidirectionally communicates with the external network (220 in FIG. 1) by being interconnected therewith.

The internal network connection module 320 includes an internal network transceiver 321, a first transceiver 322, an internal network bypass switch 323, and the like.

The internal network transceiver 321 bidirectionally communicates with the internal network (210 in FIG. 1), sends data received from the internal network (210 in FIG. 1) to the first transceiver 322, and receives data from the first transceiver 322 via the internal network bypass switch 323.

Here, data to be sent from the first transceiver 322 to the internal network transceiver 321 may be data that were received from the intermediate connection module 330 in order to be sent from the external network (220 in FIG. 1) to the internal network (210 in FIG. 1).

Here, the internal network transceiver 321 may send a control signal in order to control the state of the internal network bypass switch 323.

Here, the internal network transceiver 321 may send a control signal in order to control the state of an external network bypass switch 343.

The internal network bypass switch 323 performs control in order to enable or disable first one-way communication from the first transceiver 322 to the internal network transceiver 321.

Here, the internal network bypass switch 323 may send a control signal in order to control the state of the external network bypass switch 343.

In FIG. 13, for clarity of description, communication between the internal network transceiver 321 and the first transceiver 322 has been described as being configured with two types of one-way communication having different directions, but communication therebetween includes not only the use of two one-way communication channels that are physically separate from each other but also the use of a two-way communication channel in which the direction of communication may be set.

The intermediate connection module 330 includes a second transceiver 331, a storage unit 332, a data verification unit 333, and the like.

The second transceiver 331 bidirectionally communicates with the first transceiver 322 in the internal network connection module 320 and a third transceiver 341 in the external network connection module 340 by being interconnected with the internal network connection module 320 and the external network connection module 340.

The storage unit 332 temporarily stores data received by the second transceiver 331.

The data verification unit 333 checks the data stored in the storage unit 332.

Here, the data verification unit 333 may perform at least one of scanning for malicious code, integrity verification, and scanning for viruses.

Here, when the second transceiver 331 sends data to the first transceiver 322 in the internal network connection module 320 or to the third transceiver 341 in the external network connection module 340, the second transceiver 331 may send only data that pass the checking process performed by the data verification unit 333.

The external network connection module 340 includes the third transceiver 341, an external network transceiver 342, the external network bypass switch 343, and the like.

The external network transceiver 342 bidirectionally communicates with the external network (220 in FIG. 1), sends data received from the external network (220 in FIG. 1) to the third transceiver 341 via the external network bypass switch 343, and receives data from the third transceiver 341.

Here, data to be sent from the third transceiver 341 to the external network transceiver 342 may be data that were received from the intermediate connection module 330 in order to be sent from the internal network (210 in FIG. 1) to the external network (220 in FIG. 1).

The external network bypass switch 343 performs control in order to enable or disable second one-way communication from the external network transceiver 342 to the third transceiver 341.

Here, the external network bypass switch 343 may be controlled depending on a control signal transmitted from the internal network transceiver 321 or the internal network bypass switch 323.

Here, the external network bypass switch 343 may send a signal indicating the state thereof to the third transceiver 341.

Here, the third transceiver 341 may send a request for two-way communication with the external network (220 in FIG. 1), which is received from the intermediate connection module 330, to the external network bypass switch 343.

In FIG. 13, for clarity of description, communication between the third transceiver 341 and the external network transceiver 342 has been described as being configured with two types of one-way communication having different directions, but communication therebetween includes not only the use of two one-way communication channels that are physically separate from each other but also the use of a two-way communication channel in which the direction of communication may be set.

The above-described embodiment of the present invention may be implemented as program instructions executable by various computer components, and may be recorded in computer-readable storage media. The computer-readable storage media may separately or collectively include program instructions, data files, data structures, and the like. The program instructions recorded in the computer-readable storage media may be specially designed and configured for the embodiment, or may be available by being well known to computer software experts. Examples of the computer-readable storage media include magnetic media such as a hard disk, a floppy disk and a magnetic tape, optical media such as a CD-ROM and a DVD, and magneto-optical media such as a floptical disk, ROM, RAM, flash memory, and the like, that is, a hardware device specially configured for storing and executing program instructions. Examples of the program instructions include not only machine code made by a compiler but also high-level language code executable by a computer using an interpreter. The above-mentioned hardware device may be configured such that it operates as one or more software modules in order to perform the operations of the embodiment, and vice-versa.

According to the present invention, through the apparatus and method for supporting data communication between separate networks, data transmission from an internal network to an external network is allowed but data transmission from the external network to the internal network is controlled. Accordingly, the two types of one-way communication having different directions may be separately managed, and communication from the external network may be physically managed, whereby security may be improved.

Also, according to the present invention, through the apparatus and method for supporting data communication between separate networks, direct two-way communication between an internal network and an external network is physically prevented. Accordingly, even in the event of a threat of malicious code or a backdoor attack that requires a two-way simultaneous connection between the internal network and the external network, a direct two-way link therebetween is prevented, whereby more improved security and safety may be guaranteed.

Although specific embodiments have been described in the specification, they do not limit the scope of the present invention. For the conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, corresponding components may not be absolutely necessary.

Accordingly, the spirit of the present invention should not be construed as being limited to the above-described embodiments, and the entire scope of the appended claims and their equivalents will fall within the scope and spirit of the present invention.

What is claimed is:

1. An apparatus for supporting data communication between separate networks, comprising:
an internal network connection module for sending data, received from an internal network, to an intermediate connection module through one-way communication and sending data, received from the intermediate connection module through first one-way communication under control of an internal network bypass switch, to the internal network;
an external network connection module for sending data, received from the intermediate connection module through one-way communication, to an external network and sending data, received from the external network, to the intermediate connection module through second one-way communication under control of an external network bypass switch; and
the intermediate connection module for temporarily storing and managing intermediate data received from the internal network connection module or the external network connection module.

2. The apparatus of claim 1, wherein the internal network bypass switch and the external network bypass switch operate in a mutually exclusive manner.

3. The apparatus of claim 2, wherein the internal network connection module controls the internal network bypass switch by sending a control signal thereto.

4. The apparatus of claim 3, wherein the internal network bypass switch and the external network bypass switch are controlled using one or more of enabling/disabling a bypass connection and enabling/disabling supply of power.

5. The apparatus of claim 4, wherein the external network bypass switch is controlled by receiving an external network bypass switch control signal that is generated in the internal network connection module or in the internal network bypass switch.

6. The apparatus of claim 5, wherein if the first one-way communication is enabled, the external network bypass switch control signal to be sent to the external network bypass switch is a control signal for disabling the second one-way communication.

7. The apparatus of claim 6, wherein the intermediate connection module is configured to:
check at least one of whether the intermediate data include malicious code, whether integrity of the intermediate data is maintained, and whether the intermediate data are infected with viruses; and
send only data that pass checking when sending the intermediate data.

8. The apparatus of claim 7, wherein the internal network connection module is configured to:
determine whether to perform data communication with an external network device, which is connected to the external network, using whitelists respectively corresponding to the internal network bypass switch and the external network bypass switch; and
control the internal network bypass switch and the external network bypass switch depending on determination of whether to perform data communication.

9. The apparatus of claim 8, wherein the intermediate connection module requests two-way communication with the external network connection module when the second one-way communication is enabled by the external network bypass switch, when the first one-way communication is disabled by the internal network bypass switch, or periodically.

10. A method for supporting data communication between separate networks, comprising:
controlling first one-way communication from an intermediate connection module to an internal network connection module using an internal network bypass switch, the intermediate connection module communicating between the internal network connection module, which communicates with an internal network, and an external network connection module, which communicates with an external network;
controlling second one-way communication from the external network connection module to the intermediate connection module using an external network bypass switch;
communicating with the internal network in such a way that the internal network connection module and the intermediate connection module communicate with each other through one-way communication from the internal network connection module to the intermediate connection module and through the first one-way communication;
communicating with the external network in such a way that the intermediate connection module and the external network connection module communicate with each other through one-way communication from the intermediate connection module to the external network connection module and through the second one-way communication; and
temporarily storing and managing intermediate data when the intermediate connection module receives the data.

11. The method of claim 10, wherein the internal network bypass switch and the external network bypass switch operate in a mutually exclusive manner.

12. The method of claim 11, further comprising:
delivering an internal network bypass switch control signal generated in the internal network connection module to the internal network bypass switch,
wherein controlling the first one-way communication is configured to control the internal network bypass switch depending on the internal network bypass switch control signal.

13. The method of claim 12, wherein:
controlling the first one-way communication is configured to control the first one-way communication using one or more of enabling/disabling a bypass connection of the internal network bypass switch and enabling/disabling supply of power to the internal network bypass switch; and
controlling the second one-way communication is configured to control the second one-way communication using one or more of enabling/disabling a bypass connection of the external network bypass switch and enabling/disabling supply of power to the external network bypass switch.

14. The method of claim 13, further comprising:
sending an external network bypass switch control signal generated in the internal network connection module or in the internal network bypass switch to the external network bypass switch,
wherein controlling the second one-way communication is configured to control the external network bypass switch depending on the external network bypass switch control signal.

15. The method of claim 14, wherein if the first one-way communication is enabled, the external network bypass switch control signal to be sent to the external network bypass switch is a control signal for disabling the second one-way communication.

16. The method of claim 15, wherein:
temporarily storing and managing the intermediate data comprises checking at least one of whether the intermediate data include malicious code, whether integrity of the intermediate data is maintained, and whether the intermediate data are infected with viruses; and
communicating with the internal network and communicating with the external network are configured to send only data that pass the checking when sending the intermediate data.

17. The method of claim 16, further comprising:
determining whether to perform data communication between a device connected to the internal network and a device connected to the external network using whitelists respectively corresponding to the internal network bypass switch and the external network bypass switch; and
controlling the internal network bypass switch and the external network bypass switch depending on the determining whether to perform data communication.

18. The method of claim 17, further comprising:
requesting two-way communication between the intermediate connection module and the external network connection module when the second one-way communication is enabled by the external network bypass switch, when the first one-way communication is disabled by the internal network bypass switch, or periodically.
